(19) United States
(12) Patent Application Publication
(10) Pub. No.: US 2024/0427485 A1
(43) Pub. Date: Dec. 26, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: KINA ITAKURA, Kanagawa (JP)

(21) Appl. No.: 18/745,616

(22) Filed: Jun. 17, 2024

(30) Foreign Application Priority Data
Jun. 21, 2023 (JP) 2023-102042

(51) Int. Cl. G06F 3/04855; G06F 3/04815

(52) U.S. Cl. CPC G06F 3/04855; G06F 3/04815

(57) ABSTRACT

An image processing apparatus includes one or more processors and at least one memory, the at least one memory being coupled to the one or more processors and having stored thereon instructions executable by the one or more processors, wherein the execution of the instructions cause the image processing apparatus to function as an acquisition unit configured to acquire image data representing a display video in which a viewpoint for viewing is changeable, and a generation unit configured to generate data for displaying information indicating a length of a reproduction time of the display video, information indicating a range in which the viewpoint is changeable in the display video, and the display video.

### BACKGROUND OF THE DISCLOSURE

### Field of the Disclosure

The present disclosure relates to an image processing technique for displaying a wide viewing angle video.

### Description of the Related Art

A wide viewing angle video of surroundings at 360 or 180 degrees can be viewed in an arbitrary line-of-sight direction specified by a viewer from a reference viewpoint position, which is a position where a camera is set.

Japanese Patent Application Laid-Open No. 11-27703 discusses a technique for enabling a viewer to change a line-of-sight direction of a video displayed on a screen by performing a predetermined operation on the displayed video and for displaying a user interface that indicates the line-of-sight direction of the displayed video on the screen.

### SUMMARY OF THE DISCLOSURE

According to an aspect of the present disclosure, an image processing apparatus includes one or more processors and at least one memory, the at least one memory being coupled to the one or more processors and having stored thereon instructions executable by the one or more processors, wherein the execution of the instructions cause the image processing apparatus to function as an acquisition unit configured to acquire image data representing a display video in which a viewpoint for viewing is changeable, and a generation unit configured to generate data for displaying information indicating a length of a reproduction time of the display video, information indicating a range in which the viewpoint is changeable in the display video, and the display video.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of an image processing apparatus.

FIG. 2 is a block diagram illustrating a configuration of an image processing apparatus according to a first exemplary embodiment.

FIG. 3 is a flowchart illustrating a processing flow of the image processing apparatus according to the first exemplary embodiment.

FIG. 4 is a schematic drawing of a display screen on a reproduction player according to the first exemplary embodiment.

FIG. 5 is a block diagram illustrating a functional configuration of an image processing apparatus according to a second exemplary embodiment.

FIG. 6 is a flowchart illustrating a processing flow of the image processing apparatus according to the second exemplary embodiment.

FIG. 7 is a schematic drawing of a display screen on a reproduction player according to the second exemplary embodiment.

FIG. 8 is a block diagram illustrating a configuration of an image processing apparatus according to a third exemplary embodiment.

FIG. 9 is a flowchart illustrating a processing flow of the image processing apparatus according to the third exemplary embodiment.

### DESCRIPTION OF THE EMBODIMENTS

Exemplary embodiments of the present disclosure will be described with reference to the attached drawings. The exemplary embodiments are not meant to limit the present disclosure, and not all combinations of features described in the present exemplary embodiments are essential for solving means of the present disclosure. The same configurations are described with the same reference numerals.

According to the technique discussed in Japanese Patent Application Laid-Open No. 11-27703, it is not possible to search for a video in a direction different from the line-of-sight direction of the displayed video in a state where the video is being displayed. For example, if a viewer searches for another line-of-sight direction while viewing a video in an arbitrary line-of-sight direction (viewpoint), the viewer needs to change the line-of-sight direction of the displayed video itself. If the viewer wants to return to the original line-of-sight direction as a result of the change, the viewer needs to perform a similar operation again. Because the viewer relies on the line-of-sight direction on a user interface to adjust the line-of-sight direction to the original line-of-sight direction, the adjusted result does not necessarily match the original line-of-sight direction.

As described above, the technique discussed in Japanese Patent Application Laid-Open No. 11-27703 has room for improvement in operability and searchability in searching for a video from another viewpoint while viewing the video.

According to a first exemplary embodiment, a method is described for displaying a seek bar indicating time-related information and a seek bar indicating direction-related information and displaying a thumbnail image on the seek bar in a reproduction player that reproduces a wide viewing angle video in which a user can change a viewpoint to view. An outline of the present exemplary embodiment will be described.

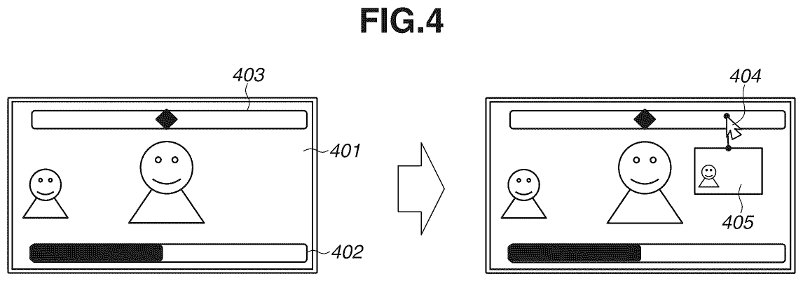

FIG. 4 is an example of a schematic drawing of a display screen to be presented to a user on a reproduction player according to the present exemplary embodiment. An area 401 in FIG. 4 is an area where a video is displayed that corresponds to a partial area in a scene represented by a wide viewing angle video.

The video in the partial area generated from the wide viewing angle image being displayed or one or more frame images included in the video is referred to as a display video. The display video is a part of the wide viewing angle video generated from the wide viewing angle video based on a line-of-sight direction specified by a user. The line-of-sight direction is a direction represented by a line connecting a viewpoint of the user when viewing the display video and a subject in the display video. Even in a wide viewing angle video, there is a limit to an angle of view (viewing angle), and a range in which a viewpoint can be set or changed is limited according to a video acquired in capturing.

A bar 402 in FIG. 4 is a seek bar (hereinbelow referred to as a time seek bar), which is an object indicating time-related information, and indicates a display time of the display video with respect to an entire time of the wide viewing angle video as a ratio of a filled amount to the entire bar. For example, if a length of a video is six minutes and the video at three minutes from the start of the video is displayed as the display video, the bar 402 is displayed filled to half the length of the entire reproduction time. The filled amount of the seek bar changes according to the change in the display time of the display video of the bar 402.

Representation of the time seek bar is not limited to filling, and other representation methods may be used as long as a user can recognize the position on the seek bar as the elapsed time from the start of the video, such as displaying a mark on the seek bar.

The user can change the display video to the video at a specified time by performing an action, such as clicking, to instruct a change of time at a desired position on the time seek bar. For example, in a case where the user performs an action to instruct a change of time at the half position of the seek bar, if the length of the video is six minutes, the video displayed in the area 401 is changed to the video at three minutes from the start of the video.

A bar 403 in FIG. 4 is a seek bar (hereinbelow referred to as a direction seek bar) indicating direction-related information, and a position of a mark with respect to the entire bar represents the line-of-sight direction of the video to be displayed in the area 401, assuming that a horizontal angle of view of the wide viewing angle video is the entire length of the seek bar. In other words, in a case where the line-of-sight direction or a position of a subject does not change over time, the direction seek bar indicates, by length, a range in which the position of the viewpoint can be changed in the horizontal direction. For example, if the horizontal angle of view of the wide viewing angle video is 360 degrees, and the line-of-sight direction of the display video is 90 degrees horizontally to the right from the center of the wide viewing angle video, a mark is displayed at a position ¾ of the length from a left end of the bar 403.

The user can change the line-of-sight direction of the display video to a specified direction by performing an action, such as clicking, to instruct a change of the line-of-sight direction at a desired position on the bar 403 indicating the direction-related information. In this case, the position of the mark on the seek bar changes according to the change in the line-of-sight direction of the display video.

Representation of the direction seek bar is not limited to this example, and other representation methods such as other marks may be used as long as the user can recognize the position on the seek bar. In the above-described example, the horizontal angle of view of the wide viewing angle video is assumed as the entire length of the seek bar, but the representation methods are not limited to the above-described example, and a vertical angle of view of the wide viewing angle video may be assumed as the entire length of the seek bar. A two-axis seek bar corresponding to each of the horizontal and vertical directions may be provided as the direction seek bar.

In FIG. 4, a cursor 404 indicates a position where the user is operating on the reproduction player. In a case where the user operates the cursor on the direction seek bar or the time seek bar, the reproduction player according to the present exemplary embodiment displays a thumbnail image 405 according to a cursor position. For example, in a case where the user operates the cursor 404 on the direction seek bar 403 as illustrated in FIG. 4, a video in the direction corresponding to the cursor position at the display time of the display video is displayed as the thumbnail image 405. In a case where the user operates the cursor 404 on the time seek bar, a video at the time corresponding to the cursor position in the line-of-sight direction of the display video is displayed as the thumbnail image 405 on the bar 402.

Representation of the cursor 404 illustrated in FIG. 4 is not limited to this example, and any method may be used as long as the user can recognize his/her operating position. A display position and representation method of the thumbnail image 405 are also not limited to those examples illustrated in FIG. 4, and any method may be used as long as the user can recognize whether the thumbnail image 405 corresponds to the time or the direction seek bar.

The above described is the outline of the reproduction player according to the present exemplary embodiment. In the above-described reproduction player, a user operation on the direction seek bar is used to change the line-of-sight direction of the display video, but the operation is not limited to this example, and the line-of-sight direction of the display video may be directly changed by clicking and moving the display video right and left. In this case, the position of the mark on the direction seek bar may change to follow a change in the line-of-sight direction of the display video.

In other words, user operations on time and direction may be performed independently of each other.

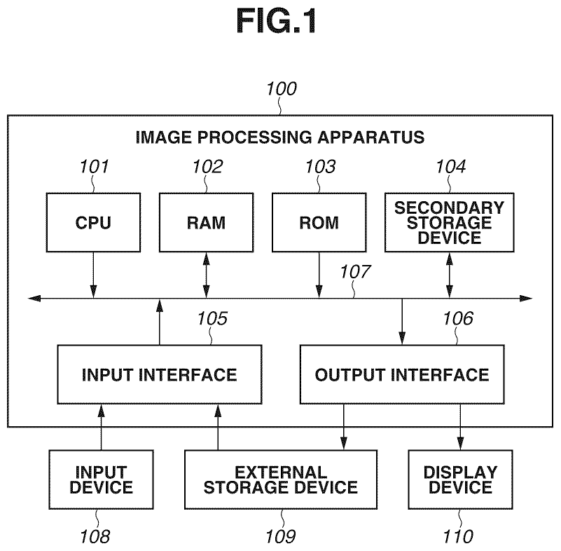

A specific configuration according to the present exemplary embodiment is to be described. FIG. 1 illustrates an example of a hardware configuration of an image processing apparatus according to the first exemplary embodiment. In FIG. 1, an image processing apparatus 100 according to the first exemplary embodiment includes a central processing unit (CPU) 101, a random access memory (RAM) 102, a read-only memory (ROM) 103, a secondary storage device 104, an input interface 105, and an output interface 106. Each component of the image processing apparatus 100 is connected to each other by a system bus 107. The image processing apparatus 100 is connected to an input device 108 and an external storage device 109 via the input interface 105, and is connected to the external storage device 109 and a display device 110 via the output interface 106.

The CPU 101 is a processor that uses the RAM 102 as a work memory and executes a program stored in the ROM 103 to comprehensively control each component of the image processing apparatus 100 via the system bus 107. Accordingly, various types of processing described below are executed.

The secondary storage device 104 is a storage device that stores various data handled in the image processing apparatus 100, and a hard disk drive (HDD) is used in the present exemplary embodiment. The CPU 101 can write data to the secondary storage device 104 and read data stored in the secondary storage device 104 via the system bus 107. In addition to the HDD, various storage devices such as an optical disk drive and a flash memory can be used as the secondary storage device 104.

The input interface 105 is, for example, a serial bus interface of Universal Serial Bus (USB), Institute of Electrical and Electronics Engineers (IEEE) 1394, or the like, and data, an instruction, and the like are input from an external device to the image processing apparatus 100 via the input interface 105. The image processing apparatus 100 acquires data from the input device 108 (e.g., a mouse, a button, and a keyboard) and the external storage device 109 (e.g., a hard disk, a memory card, and a USB stick) via the input interface 105.

The output interface 106 includes a serial bus interface of USB, IEEE 1394, or the like, as with the input interface 105. In addition, other video output terminals such as a digital visual interface (DVI) and a High-Definition Multimedia Interface (HDMI®) can be used as the output interface 106. Data and the like are output from the image processing apparatus 100 to the external device via the output interface 106. The image processing apparatus 100 displays an image by outputting a processed image or the like to the display device 110 (various image display devices such as a liquid crystal display) via the output interface 106. The image processing apparatus 100 includes components other than those described above, but descriptions of the other components are omitted because they are not the main focus of the present disclosure.

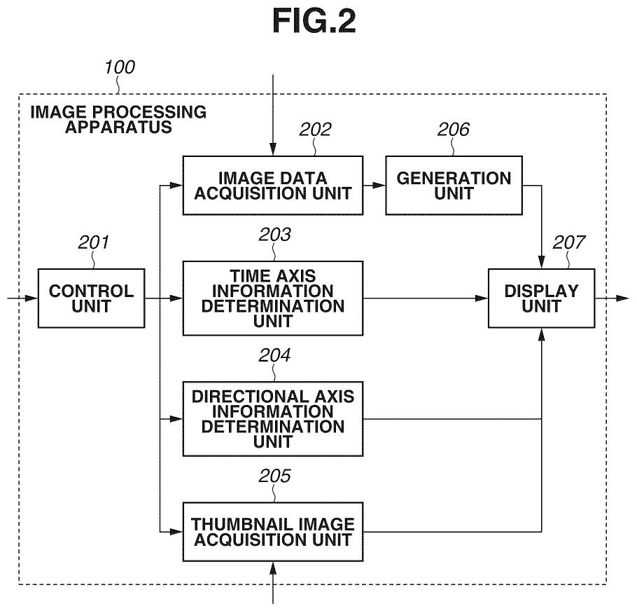

FIG. 2 is a block diagram illustrating the configuration of the image processing apparatus 100 according to the present exemplary embodiment.

A control unit 201 generates information to be output to each component in response to a user operation using the input device 108 acquired via the input interface 105, and outputs the information to each component. Specifically, in a case where the user operation is to reproduce or stop the display video, the control unit 201 outputs information for reproducing or stopping the display video to an image data acquisition unit 202.

In a case where the user operation is to change the display time or the line-of-sight direction of the display video, the control unit 201 outputs user specified information representing information about the changed display time or line-of-sight direction to the image data acquisition unit 202, a time axis information determination unit 203, and a directional axis information determination unit 204.

An example of a user operation for changing the display time or the line-of-sight direction includes a click action on the time seek bar and the direction seek bar as described above. The user operation is not limited to this example, and any method may be used as long as the user can uniquely sets a specified time or direction, such as by specifying a numerical value of the display time or the line-of-sight direction using the keyboard.

The user specified information according to the present exemplary embodiment is information including a set of display time Tp [seconds] and direction Vp=(Vph, Vpv) [degrees] specified by the user. The direction Vp is expressed as horizontal Vph and vertical Vpv, which are the angles formed between the center direction of the wide viewing angle video and the line-of-sight direction specified by the user. The method for expressing the display time and the line-of-sight direction specified by the user is not limited to this example, and any method may be used as long as the specified display time and line-of-sight direction can be uniquely set.

In a case where the user operation is performed on the time seek bar or the direction seek bar, the control unit 201 outputs user operation position information on the reproduction player to a thumbnail image acquisition unit 205.

The user operation position information according to the present exemplary embodiment is expressed as a coordinate position (x, y) where an upper left of the reproduction player is the origin, the horizontal direction is an x axis, and the vertical direction is a y axis. The user operation position information is not limited to this example, and any method may be used that can indicate the user operation position on the reproduction player.

The image data acquisition unit 202 acquires image data of one frame in the wide viewing angle video from the external storage device 109 or the secondary storage device 104. The image data of one frame to be acquired is a frame corresponding to the display time of the display video managed in the RAM 102 or the display time specified by the user in the user specified information acquired from the control unit 201.

The image data acquisition unit 202 does not need to always acquire image data and does not need to newly acquire image data if it has acquired stop information from the control unit 201.

The image data acquisition unit 202 outputs the acquired image data and the user operation information acquired from the control unit 201 to a generation unit 206.

The time axis information determination unit 203 determines time seek bar information based on the user specified information in a case where the user specified information is acquired from the control unit 201, and determines the time seek bar information based on the display time of the display video managed in the RAM 102 in a case where the user specified information is not acquired. The time seek bar information is information defining an area to be filled for the entire time seek bar. The area to be filled is determined by a ratio Tp/Tf of the display time in the user specified information or the display time Tp of the display video managed in the RAM 102 to an entire time Tf of wide viewing angle video data.

The time axis information determination unit 203 outputs the time seek bar information to a display unit 207. As described above, the representation of the time seek bar is not limited to filling, so that the time seek bar information is changed depending on the representation method.

The directional axis information determination unit 204 determines direction seek bar information based on the user specified information in a case where the user specified information is acquired from the control unit 201, and determines the direction seek bar information based on the line-of-sight direction of the display video managed in the RAM 102 in a case where the user specified information is not acquired. The direction seek bar information is information indicating the position where the mark is displayed if the left end of the direction seek bar is the origin, and is expressed as a ratio to the entire length of the direction seek bar as 1. The ratio is determined by a ratio Vp/Vf of the line-of-sight direction in the user specified information or the line-of-sight direction Vp of the display video managed in the RAM 102 to an entire angle of the view Vf of the wide viewing angle video data.

At this time, the information used is changed as appropriate according to the direction represented by the direction seek bar. For example, in a case where the direction seek bar represents only the horizontal direction, the horizontal direction element Vph of the direction Vp and the horizontal angle of view of the wide viewing angle video are used. The time axis information determination unit 203 outputs the time seek bar information to the display unit 207.

The thumbnail image acquisition unit 205 calculates a time and a line-of-sight direction in a thumbnail image from the user operation position information acquired from the control unit 201 and the display time and the line-of-sight direction of the display video managed in the RAM 102, and acquires the thumbnail image in the calculated time and direction.

The time in the thumbnail image in a case where a coordinate position of the operation position information is on the time seek bar is to be described. The time in this case is calculated as a ratio of a length from the coordinate position of the left end of the time seek bar to the coordinate position of the operation position information to a length from the coordinate position of the left end to the coordinate position of the right end of the time seek bar.

The time in the thumbnail image is determined by a product of the entire time of the wide viewing angle video data and the calculated ratio. The line-of-sight direction in the thumbnail image at this time is the line-of-sight direction of the display video managed in the RAM 102. In a case where the coordinate position of the operation position information is on the direction seek bar, the line-of-sight direction in the thumbnail image is determined as follows. In other words, the line-of-sight direction is calculated by a ratio of the length from the coordinate position of the left end of the direction seek bar to the coordinate position of the operation position information to a length from the coordinate position of the left end to the coordinate position of the right end of the direction seek bar.

The line-of-sight direction in the thumbnail image is determined by a product of the entire angle of the view of the wide viewing angle video data and the calculated ratio. The time in the thumbnail image at this time is the display time of the display video managed in the RAM 102.

The thumbnail image acquisition unit 205 acquires the thumbnail image corresponding to the calculated time and line-of-sight direction from the external storage device 109 or the secondary storage device 104 via the input interface 105, and outputs the acquired thumbnail image to the display unit 207.

The present exemplary embodiment is described assuming that thumbnail images with different times and different directions are generated and stored in advance, but the present disclosure is not limited to the above-described example, and the thumbnail image may be generated from the wide viewing angle video data.

The generation unit 206 generates the display video to be displayed on the reproduction player from the image data acquired from the image data acquisition unit 202. The display video is generated by cutting out an area corresponding to an arbitrarily determined angle of view from the image data, centered on the line-of-sight direction of the display video managed in the RAM 102 or the line-of-sight direction in the user operation information acquired from the control unit 201. The generation unit 206 outputs the generated display video to the display unit 207.

The display unit 207 generates data to be displayed on the display device 110 based on the information acquired from each unit, and transmits the data to the display device 110. In other words, the display unit 207 generates data using the display video from the generation unit 206, the time seek bar information from the time axis information determination unit 203, the direction seek bar information from the directional axis information determination unit 204, and the thumbnail image from the thumbnail image acquisition unit 205. In the display, respective image objects of the time seek bar, the direction seek bar, and the thumbnail image are displayed to be superimposed on the display video as the above-described example in FIG. 4. Instead of being superimposed, the time seek bar, the direction seek bar, and the thumbnail image may be displayed, being arranged around an area where the display video is displayed.

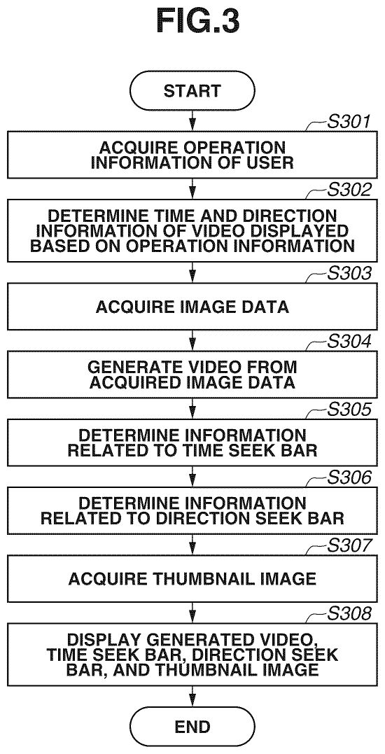

A processing flow of the image processing apparatus 100 according to the present exemplary embodiment is to be described with reference to a flowchart in FIG. 3. The image processing apparatus 100 executes a series of processing illustrated in the flowchart in FIG. 3 by having the CPU 101 execute a program stored in the ROM 103 using the RAM 102 as a work memory. It is not necessary that all the processing to be described below be executed by the CPU 101, and the image processing apparatus 100 may be configured so that a part or all of the processing is performed by one or more processing circuits other than the CPU 101. In the following flowchart, each process (step) is indicated with “S”.

In step S301, the control unit 201 acquires operation information from a user.

In step S302, the control unit 201 calculates information about the display time and the line-of-sight direction of the display video based on the operation information from the user, and outputs the information to the image data acquisition unit 202, the time axis information determination unit 203, the directional axis information determination unit 204, and the thumbnail image acquisition unit 205.

In step S303, the image data acquisition unit 202 acquires image data that is a source of the display video.

In step S304, the generation unit 206 generates the display video from the image data acquired from the image data acquisition unit 202.

In step S305, the time axis information determination unit 203 determines information related to the time seek bar based on the user operation information acquired from the control unit 201 or the display time of the display video managed in the RAM 102.

In step S306, the directional axis information determination unit 204 determines information related to the direction seek bar based on the user operation information acquired from the control unit 201 or the line-of-sight direction of the display video managed in the RAM 102.

In step S307, the thumbnail image acquisition unit 205 acquires the thumbnail image based on the user operation information acquired from the control unit 201.

In step S308, the display unit 207 displays the display video, the time seek bar, the direction seek bar, and the thumbnail image as illustrated in FIG. 4.

If the processing in step S308 is completed, the processing according to the present exemplary embodiment is completed.

The above described is the processing executed by the image processing apparatus 100 according to the present exemplary embodiment.

According to the present exemplary embodiment, a reproduction player that reproduces a wide viewing angle video displays a seek bar indicating time-related information and a seek bar indicating direction-related information, and displays a thumbnail image on the seek bar. Accordingly, in viewing a wide viewing angle video, a user can search for a video in a direction different from the displayed video while viewing the video, so that operability and searchability can be improved.

According to the first exemplary embodiment, a method is described for a reproduction player that reproduces a wide viewing angle video to display a seek bar indicating time-related information and a seek bar indicating direction-related information and to display a thumbnail image on the seek bar.

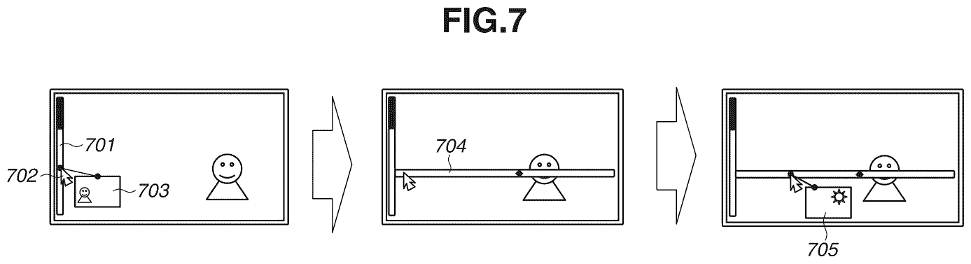

According to a second exemplary embodiment, among thumbnail images to be displayed on seek bars, a thumbnail image corresponding to a time or a direction specified on the other seek bar is displayed. An outline and significance of a reproduction player according to the second exemplary embodiment are described with reference to FIG. 7.

In FIG. 7, a bar 701 is a time seek bar, a cursor 702 indicates a position where a user is operating on the reproduction player, and a thumbnail image 703 corresponds to the position where the user operates.

The user can search for a video at a different time from a time of the display video by checking the thumbnail image corresponding to the operation on the time seek bar.

If the user instructs an operation specified in the reproduction player on the time seek bar, a direction seek bar as illustrated in a bar 704 is displayed. The specified operation may be any operation as long as an instruction from the user can be identified, such as a key input from a keyboard, left click on a mouse, and moving a cursor position in the vertical direction on the time seek bar. In FIG. 7, the bar 704 is displayed along a position of the cursor 702 of the user, but the display position is not limited to this example, and the bar 704 may be displayed at any position on the reproduction player.

The reproduction player displays a thumbnail image 705 in a direction corresponding to a position where the user performs an operation on the direction seek bar. At this time, the thumbnail image 705 is an image at the time determined by the bar 701, which is different from the display time of the display video.

In the reproduction player described according to the first exemplary embodiment, a thumbnail image to be displayed on the direction seek bar is a video in a different line-of-sight direction at the same time as the display video. Thus, if a user wants to search for a video at a different time and in a different line-of-sight direction than the display video, the user needs to operate the time seek bar to switch the display video at the desired time and then to operate the direction seek bar. The same is true even if the order of operations for time and direction is reversed. In either case, if the user wants to search for a video at a different time and in a different direction than the display video, the user needs to switch the display video once.

In contrast, with the reproduction player according to the second exemplary embodiment, a user can search for a video at a different time and in a different line-of-sight direction than the display video, without switching the display video, so that operability and searchability can be further improved.

The reproduction player and the operation procedure illustrated in FIG. 7 are just examples, and the representation method and operation method of the reproduction player are not limited to these examples. For example, in the above-described example, the time seek bar is operated, and then the direction seek bar is operated, but the order may be reversed. The direction seek bar illustrated as one axis in FIG. 7 may also be represented as two axes, horizontal and vertical. In FIG. 7, the time seek bar is displayed vertically, but it may also be displayed horizontally. In FIG. 7, the direction seek bar is displayed after the time seek bar is operated, but the order may be reversed, and both the seek bars may be displayed at all times.

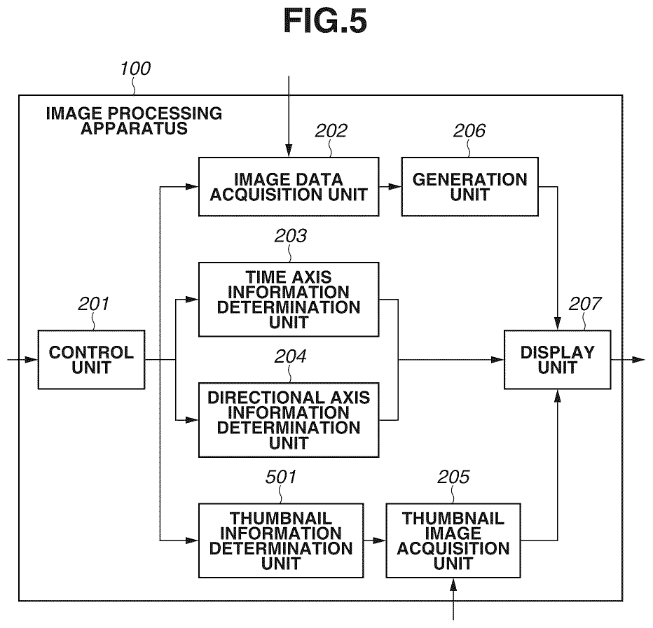

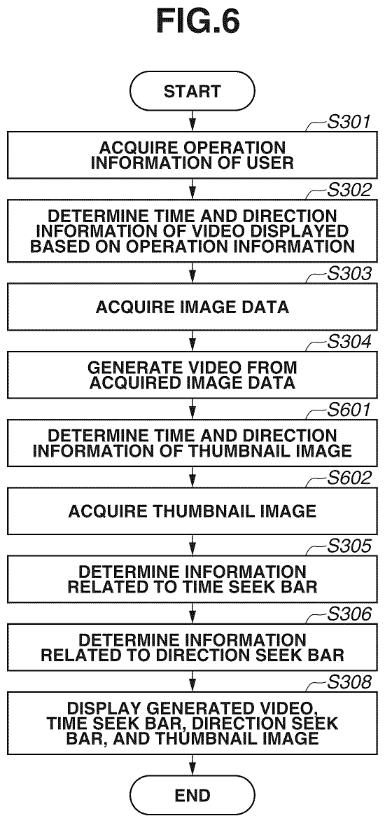

Processing executed by the image processing apparatus 100 according to the present exemplary embodiment is to be described. FIG. 5 is a block diagram illustrating a configuration of the image processing apparatus 100 according to the present exemplary embodiment. The image processing apparatus 100 functions as each component illustrated in FIG. 5 and executes a series of processing illustrated in a flowchart in FIG. 6 by having the CPU 101 execute a program stored in the ROM 103 using the RAM 102 as a work memory.

It is not necessary that all the processing to be described below be executed by the CPU 101, and the image processing apparatus 100 may be configured so that a part or all of the processing is performed by one or more processing circuits other than the CPU 101. The same configurations and the same processing as those in the first exemplary embodiment are denoted by the same reference numerals as those in the first exemplary embodiment, and the descriptions thereof are omitted.

The control unit 201, in which a relationship between components changes from that in the first exemplary embodiment, and a thumbnail information determination unit 501, which is newly added in the second exemplary embodiment are described.

If a user operation is an instruction on the seek bar specified in the reproduction player as described above, the control unit 201 outputs user operation position information on the reproduction player to the thumbnail information determination unit 501.

The thumbnail information determination unit 501 determines a time Ts and a line-of-sight direction Vs in a thumbnail image based on the user operation position information acquired from the control unit 201.

In a case where a coordinate position of the operation position information is on the time seek bar, the time Ts in the thumbnail image is calculated by a ratio of a length from the left end of the time seek bar to the coordinate position of the operation position information to the length from the coordinate position of the left end to the coordinate position of the right end of the time seek bar. The time Ts in the thumbnail image is determined by a product of the entire time of the wide viewing angle video data and the calculated ratio.

In a case where the coordinate position of the operation position information is on the direction seek bar, the line-of-sight direction Vs in the thumbnail image is calculated by a ratio of a length from the left end of the direction seek bar to the coordinate position of the operation position information to the length from the coordinate position of the left end to the coordinate position of the right end of the direction seek bar. The line-of-sight direction Vs in the thumbnail image is determined by a product of the entire angle of the view of the wide viewing angle video data and the calculated ratio.

The thumbnail information determination unit 501 outputs the determined time Ts and line-of-sight direction Vs of the thumbnail image to the thumbnail image acquisition unit 205.

The thumbnail image acquisition unit 205 acquires a thumbnail image at the time Ts and in the line-of-sight direction Vs of the thumbnail image acquired from the thumbnail information determination unit 501. The specific method is the same as that according to the first exemplary embodiment, so that the description of the method is omitted.

Processing in steps S601 and S602 added in the second exemplary embodiment is to be described.

In step S601, the thumbnail information determination unit 501 determines information about the time and the line-of-sight direction of the thumbnail image based on the user operation position information acquired from the control unit 201.

In step S602, the thumbnail image acquisition unit 205 acquires the thumbnail image based on the information about the time and the line-of-sight direction of the thumbnail image acquired from the thumbnail information determination unit 501.

The above described is the processing executed by the image processing apparatus 100 according to the second exemplary embodiment. According to the second exemplary embodiment, a thumbnail information determination unit is added to the first exemplary embodiment, and processing for determining information about a time and a line-of-sight direction of a thumbnail image is added according to an operation on the mutual seek bars. Accordingly, a user can check a thumbnail image at a different time and in a different line-of-sight direction than the display video without switching the time and the line-of-sight direction of the display video, so that operability and searchability can be improved.

According to a third exemplary embodiment, processing for setting a reproduction speed of a display video in a reproduction player is added, and the reproduction speed is slowed down if a user is operating a direction seek bar.

In a normal viewing angle video, which is not a wide viewing angle video, a user performs an operation on a seek bar to check a thumbnail image in order to search for a video at a different time from a time of the display video. In contrast, in a case where a user operates the direction seek bar in a wide viewing angle video, the user intends to search for a video not at a different time but in a different line-of-sight direction than the display video. Thus, in a content with rapid scene changes, the content of the displayed video may change significantly while the user is searching for a video in a different line-of-sight direction, and the user may not be able to keep up with the changes in content.

According to the third exemplary embodiment, the reproduction speed of the display video is slowed down during an operation on the direction seek bar, so that it is possible to prevent a user from being unable to keep up with the changes in content.

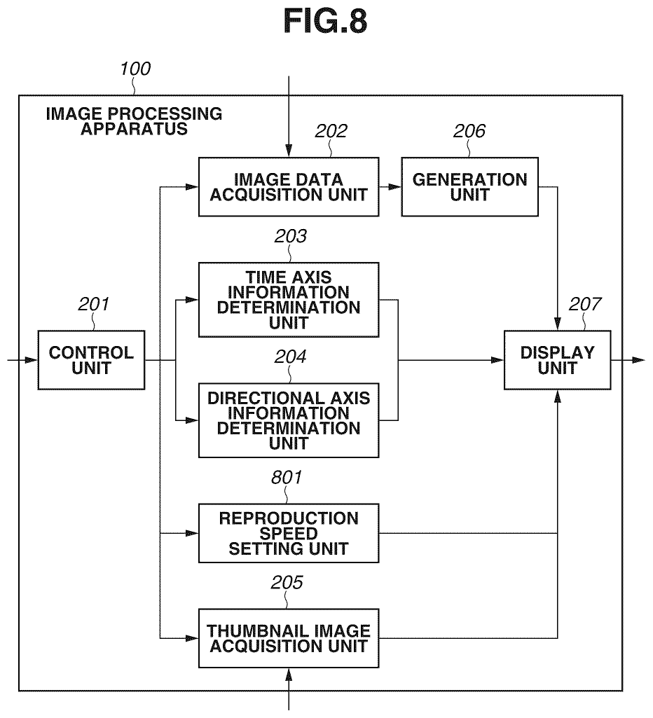

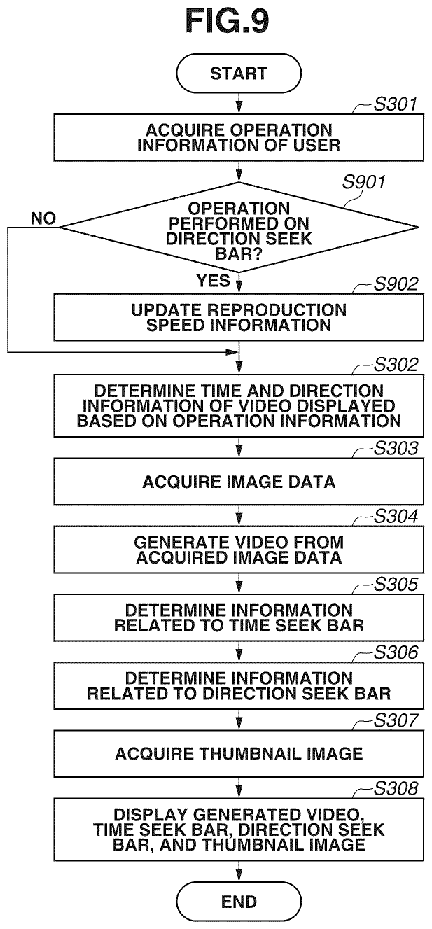

Processing executed by the image processing apparatus 100 according to the present exemplary embodiment is to be described. FIG. 8 is a block diagram illustrating a configuration of the image processing apparatus 100 according to the present exemplary embodiment. The image processing apparatus 100 functions as each component illustrated in FIG. 8 and executes a series of processing illustrated in a flowchart in FIG. 9 by having the CPU 101 execute a program stored in the ROM 103 using the RAM 102 as a work memory.

It is not necessary that all the processing described below be executed by the CPU 101, and the image processing apparatus 100 may be configured so that a part or all of the processing is performed by one or more processing circuits other than the CPU 101. The same configurations and the same processing as those in the first and the second exemplary embodiments are denoted by the same reference numerals as those in the first and the second exemplary embodiments, and the descriptions thereof are omitted.

A reproduction speed setting unit 801, which is newly added in the third exemplary embodiment is to be described.

The reproduction speed setting unit 801 acquires the user operation position information from the control unit 201 and determines whether the coordinate position of the operation position information continues to be on the direction seek bar. As a result of determination, while the coordinate position continues to be on the direction seek bar, the reproduction speed setting unit 801 generates image data by changing reproduction speed information indicating the reproduction speed of the display video in the reproduction player and outputs the reproduction speed information to the display unit 207. The reproduction speed information is expressed as a ratio if a normal speed is 1.0, and the reproduction speed information at half speed is 0.5.

According to the present exemplary embodiment, the reproduction speed information is 1.0 or a unique value less than 1.0 defined in advance, and the reproduction speed is changed in two stages, normal and slow. The display unit 207 adjusts an update timing of the display video in response to the reproduction speed acquired from the reproduction speed setting unit 801.

Processing in steps S901 and S902 added in the third exemplary embodiment is to be described.

In step S901, the reproduction speed setting unit 801 determines whether a user performs an operation on the direction seek bar based on the user operation position information acquired from the control unit 201. If it is determined that the operation is performed on the direction seek bar (YES in step S901), the processing proceeds to step S902, and if it is determined that the operation is not performed (NO in step S901), the processing proceeds to step S302.

In step S902, the reproduction speed setting unit 801 updates the reproduction speed information.

The above described is the processing executed by the image processing apparatus 100 according to the third exemplary embodiment. According to the third exemplary embodiment, a reproduction speed setting unit is added to the first exemplary embodiment, and processing is added for slowing down a reproduction speed of a display video if an operation is performed on the direction seek bar. Accordingly, a user can search for a video in a different direction from the display video without being left behind from changes in content.

The exemplary embodiments of the present disclosure are not limited to the above-described ones, and the present disclosure can include various exemplary embodiments. For example, according to the third exemplary embodiment, a case where the reproduction speed is set in two stages is described as an example, but the number of the stages is not limited to the above-described example, and two or more stages may be set.

As user operations according to the above-described exemplary embodiments, examples using a mouse and a keyboard are described, but the user operation is not limited to these examples, and various operation inputs such as a touch panel operation and a control operation can be performed.

The present disclosure can be realized by executing following processing. More specifically, a program for realizing one or more functions of the above-described exemplary embodiments is supplied to a system or an apparatus via a network or a storage medium and one or more processors in a computer of the system or the apparatus reads and executes the program. The present disclosure can also be realized by a circuit that realizes one or more functions (e.g., an application specific integrated circuit (ASIC)).

According to the present disclosure, time-related information and range-related information can be displayed in reproduction of a wide viewing angle video. Accordingly, it is possible to improve operability and searchability in searching for a video from another viewpoint while viewing a video.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-102042, filed Jun. 21, 2023, which is hereby incorporated by reference herein in its entirety.

What is claimed is:

1. An image processing apparatus comprising:
one or more processors and at least one memory, the at least one memory being coupled to the one or more processors and having stored thereon instructions executable by the one or more processors, wherein the execution of the instructions cause the image processing apparatus to function as:
an acquisition unit configured to acquire image data representing a display video in which a viewpoint for viewing is changeable; and
a generation unit configured to generate data for displaying information indicating a length of a reproduction time of the display video, information indicating a range in which the viewpoint is changeable in the display video, and the display video.

2. The image processing apparatus according to claim 1, wherein data generated by the generation unit is data for superimposing and displaying the information indicating the length of the reproduction time, the information indicating the range, and the display video on a screen.

3. The image processing apparatus according to claim 1, wherein data generated by the generation unit is data for arranging and displaying the information indicating the length of the reproduction time and the information indicating the range, around the display video on a screen.

4. The image processing apparatus according to claim 1, wherein the generation unit generates, from the acquired image data, image data representing the display video centered on a line-of-sight direction at a time of viewing the display video represented by the image data as the data.

5. The image processing apparatus according to claim 4, wherein, in a case where the viewpoint is changed, the display video in the data generated by the generation unit is a video generated with the changed viewpoint as the line-of-sight direction.

6. The image processing apparatus according to claim 1, wherein the generation unit generates the data representing the information indicating the length of the reproduction time and the information indicating the range respectively as image objects of seek bars.

7. The image processing apparatus according to claim 6, wherein, among the seek bars, a seek bar corresponding to the information indicating the range is a seek bar with one axis indicating a range in a horizontal or vertical direction of the display video.

8. The image processing apparatus according to claim 6, wherein, among the seek bars, a seek bar corresponding to the information indicating the range is a seek bar with two axes indicating respective ranges in horizontal and vertical directions of the display video.

9. The image processing apparatus according to claim 1, wherein the generation unit acquires a thumbnail image of the display video at a time specified by the information indicating the length of the reproduction time and in a range specified by the information indicating the range in the display video and generates the data.

10. The image processing apparatus according to claim 7, wherein the information indicating the length of the reproduction time and the information indicating the range are respectively a time specified on a seek bar corresponding to the time and a range specified on a seek bar corresponding to the range by a user instruction.

11. The image processing apparatus according to claim 10, wherein, while a user continues to position the user instruction on the seek bar corresponding to the range, the generation unit generates the data so that a reproduction speed of the display video is slowed down.

12. A non-transitory computer-readable storage medium storing a program for causing a computer to execute a method for processing an image, the method comprising:
acquiring image data representing a display video in which a viewpoint for viewing is changeable; and
generating data for displaying information indicating a length of a reproduction time of the display video, information indicating a range in which the viewpoint is changeable in the display video, and the display video.

13. A method for processing an image, the method comprising:
acquiring image data representing a display video in which a viewpoint for viewing is changeable; and
generating data for displaying information indicating a length of a reproduction time of the display video, information indicating a range in which the viewpoint is changeable in the display video, and the display video.
